(19) United States
(12) Patent Application Publication
(10) Pub. No.: US 2026/0270502 A1
(43) Pub. Date: Sep. 10, 2026

(54) SYSTEMS AND TECHNIQUES FOR MEDIA PROCESSING TO REMOVE PRIVATE INFORMATION

(71) Applicant: NAGRAVISION SARL, CHESEAUX-SUR-LAUSANNE (CH)

(72) Inventors: Jonathan Bennett-James, Cwmbran (GB); Craig Holbrook, Cwmbran (GB); Robert McGhee, Cwmbran (GB); Matthew Powell, Cwmbran (GB); Graham Davies, Cwmbran (GB); John Kramer, Cwmbran (GB)

(73) Assignee: NAGRAVISION SARL, CHESEAUX-SUR-LAUSANNE (CH)

(21) Appl. No.: 19/146,801

(22) PCT Filed: Jan. 9, 2024
(86) PCT No.: PCT/IB2024/050221

§ 371 Date: Jul. 9, 2025

Related U.S. Application Data
(60) Provisional application No. 63/438,303, filed on Jan. 11, 2023.

(51) Int. Cl. H04N 21/4335; H04N 21/431; H04N 21/439; H04N 21/44

(52) U.S. Cl. CPC H04N 21/4335; H04N 21/44008

(57) ABSTRACT

The present disclosure generally relates to systems and techniques for processing media. For example, aspects of the present disclosure include systems and techniques for editing media to remove personal information. Certain aspects of the present disclosure provide an apparatus for media processing including a memory and one or more processors coupled to the memory. The one or more processors may be configured to: retrieve media showing an environment as captured using a recording element; identify or receive input to identify a geographical boundary within the environment; process the media to identify a first feature within the environment; determine whether a portion of the media is to be deleted based on whether the first feature is outside the geographical boundary; and delete the portion of the media based on the determination.

### CROSS-REFERENCE TO RELATED APPLICATIONS

This application claims priority to U.S. Provisional Patent Application No. 63/438,303 filed Jan. 11, 2023, which is hereby incorporated by reference, in its entirety and for all purposes.

### FIELD

The present disclosure generally relates to systems and techniques for processing media. For example, aspects of the present disclosure include systems and techniques for editing media to remove personal information.

### BACKGROUND

A camera is a device that receives light and captures image frames, such as still images or video frames, using an image sensor. Cameras may include processors, such as image signal processors (ISPs), that can receive one or more image frames and process the one or more image frames. Cameras may be used for security and monitoring of activities. For example, a camera may be used to monitor activity at an entryway to a user's home. In some cases, the camera may identify whether activity has occurred within an activation boundary which triggers the capture of video. The video may be captured and stored in the cloud.

### SUMMARY

Certain aspects of the present disclosure provide an apparatus for media processing. The apparatus generally includes a memory and one or more processors coupled to the memory. The one or more processors may be configured to: retrieve media showing an environment as captured using a recording element; identify or receive input to identify a geographical boundary within the environment; process the media to identify a first feature within the environment; determine whether a portion of the media is to be deleted based on whether the first feature is outside the geographical boundary; and delete the portion of the media based on the determination.

In some aspects, the techniques described herein relate to a method for media processing, including: retrieving media showing an environment as captured using a recording element; identifying or receive input to identify a geographical boundary within the environment; processing the media to identify a first feature within the environment; determining whether a portion of the media is to be deleted based on whether the first feature is outside the geographical boundary; and deleting the portion of the media based on the determination.

Certain aspects of the present disclosure provide a non-transitory computer-readable medium having instructions stored thereon, that when executed by one or more processors, cause the one or more processors to: retrieve media showing an environment as captured using a recording element; identify or receive input to identify a geographical boundary within the environment; process the media to identify a first feature within the environment; determine whether a portion of the media is to be deleted based on whether the first feature is outside the geographical boundary; and delete the portion of the media based on the determination.

### BRIEF DESCRIPTION OF THE DRAWINGS

Illustrative embodiments of the present application are described in detail below with reference to the following drawing figures:

FIG. 1 illustrates an example computing device, in accordance with certain aspects of the present inventive concept.

FIG. 2 is a flow diagram illustrating example operations performed by a compliance system, in accordance with certain aspects of the present disclosure.

FIG. 3 illustrates a scene captured by a camera, in accordance with certain aspects of the present disclosure.

FIG. 4 illustrates example operations for media processing, in accordance with certain aspects of the present disclosure.

FIG. 5 illustrates an architecture of a computing system.

FIG. 6 is an illustrative example of a neural network.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

With advances in technology, cameras are being widely used to generate recordings for security and monitoring reasons. The increase in the home and workplace recordings raises concerns about the potential impact of capturing personally identifiable information (PII). In certain countries, individuals have the right to access their own data and to have that data corrected or deleted under certain regulations (e.g., the European general data protection regulation (GDPR)). Recent cases have highlighted how a consumer device being used without the knowledge of individuals per GDPR or data privacy laws can lead to normal individuals being faced with court cases and hefty fines. Almost everyone has a recording device in their pocket. While many may be happy to ignore or at least be ambivalent about being recorded in a public place, some recordings may cause issues, such as recordings taken at schools, sports games, and any recording of minors. In some cases, the recording of individuals in public may be unintentional. For instance, cameras recording activity in front of an individual's home may be intended to monitor people approaching the home, but may also capture individuals in public.

Certain aspects of the present disclosure provide an automated process for identifying data that is not compliant with regulations and removing or updating the data for compliance. Various techniques are described for identifying audio and videos that include PII, based on which one or more actions may be taken to either delete, edit, or prevent the capture of PII. Some examples of audio and video data that may be captured include media from video doorbell devices or security cameras. In some cases, for capturing video (e.g., using a video doorbell device), a user may be able to set up an area of activation. If movement is detected in this area of activation, the video recording may begin. However, once the recording is activated, any sound or image within the device's range may be recorded, even if the sound or image captures individuals in public areas.

Certain aspects provide a compliance system for retrieving stored video and processing the video to make the video compliant with privacy regulations. For example, once a video is captured and stored (e.g., on the cloud), the system described herein may review and edit the video to make the video regulation compliant (e.g., by blurring PII). In some cases, object detection may be used. For instance, a specific object may be detected within a geographical boundary, and images outside that boundary, such as a passerby or neighbor, may be blurred.

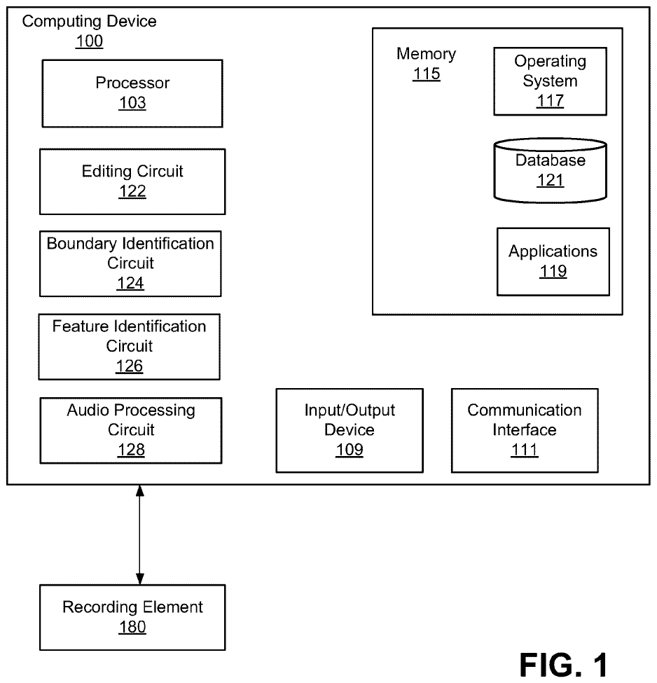

FIG. 1 illustrates an example computing device 100, in accordance with certain aspects of the present inventive concept. The computing device 100 can include a processor 103 for controlling overall operation of the computing device 100 and its associated components, including input/output device 109, communication interface 111, and/or memory 115. A data bus can interconnect processor(s) 103, memory 115, I/O device 109, and/or communication interface 111.

Input/output (I/O) device 109 can include a microphone, keypad, touch screen, and/or stylus through which a user of the computing device 100 can provide input and can also include one or more of a speaker for providing audio output and a video display device for providing textual, audiovisual, and/or graphical output. Software can be stored within memory 115 to provide instructions to processor 103 allowing computing device 100 to perform various actions. For example, memory 115 can store software used by the computing device 100, such as an operating system 117, application programs 119, and/or an associated internal database 121. The various hardware memory units in memory 115 can include volatile and nonvolatile, removable, and non-removable media implemented in any method or technology for storage of information such as computer-readable instructions, data structures, program modules or other data. Memory 115 can include one or more physical persistent memory devices and/or one or more non-persistent memory devices. Memory 115 can include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Communication interface 111 can include one or more transceivers, digital signal processors, and/or additional circuitry and software for communicating via any network, wired or wireless, using any protocol as described herein. Processor 103 can include a single central processing unit (CPU), which can be a single-core or multi-core processor (e.g., dual-core, quad-core, etc.), or can include multiple CPUs. Processor(s) 103 and associated components can allow the computing device 100 to execute a series of computer-readable instructions to perform some or all of the processes described herein. Although not shown in FIG. 1, various elements within memory 115 or other components in computing device 100, can include one or more caches, for example, CPU caches used by the processor 103, page caches used by the operating system 117, disk caches of a hard drive, and/or database caches used to cache content from database 121. For implementations including a CPU cache, the CPU cache can be used by one or more processors 103 to reduce memory latency and access time. A processor 103 can retrieve data from or write data to the CPU cache rather than reading/writing to memory 115, improving the speed of these operations. In some examples, a database cache can be created in which certain data from a database 121 is cached in a separate smaller database in a memory separate from the database, such as in RAM or on a separate computing device. For instance, in a multi-tiered application, a database cache on an application server can reduce data retrieval and data manipulation time by not needing to communicate over a network with a back-end database server. These types of caches and others can be included in various implementations and can provide potential advantages in certain implementations of software deployment systems, such as faster response times and less dependence on network conditions when transmitting and receiving data.

In certain aspects of the present disclosure, the computing device 100 may include an editing circuit 122. The editing circuit may edit (e.g., cross, cut, blur, or mute) media as described herein. In some cases, the media may be received from a recording element 180. For example, the recording element 180 may store the media in memory 115, which may later be retrieved, and in some aspects, deleted/replaced with an edited version thereof, as described herein. In some cases, the computing device 100 may include a boundary identification circuit 124. The boundary identification circuit 124 may identify a geographical boundary (e.g., associated with a property of a user), as described herein. In some aspects, the computing device 100 may include a feature identification circuit 126. The feature identification circuit 126 may identify features captured in one or more frames. For example, the feature identification circuit 126 may identify objects or people in an environment using captured video. The computing device 100 may also include an audio processing circuit 128. The audio processing circuit 128 may process audio to detect speech, as described herein.

In some aspects, editing circuit 122, boundary identification circuit 124, feature identification circuit 126, and/or audio processing circuit 128 may be implemented in software or hardware, or a combination of software and hardware. Editing circuit 122, boundary identification circuit 124, feature identification circuit 126, and/or audio processing circuit 128 may be implemented as part of processor 103, in some aspects.

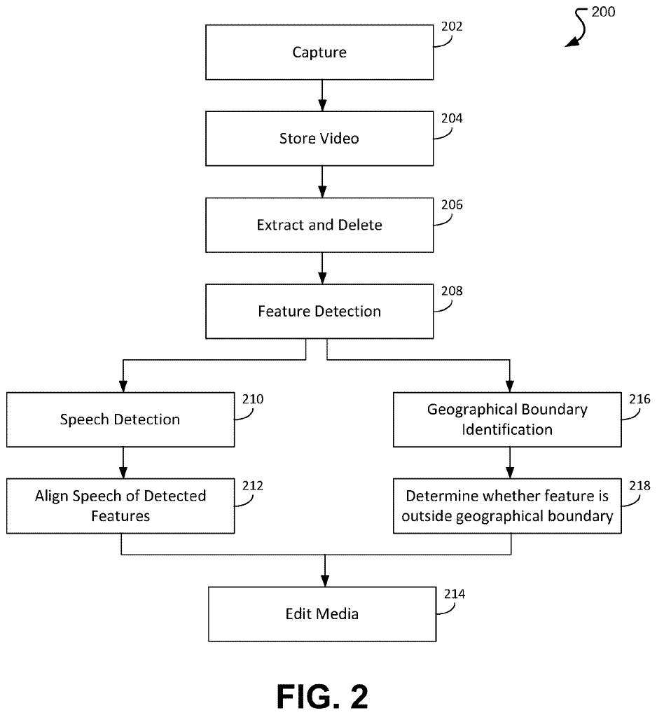

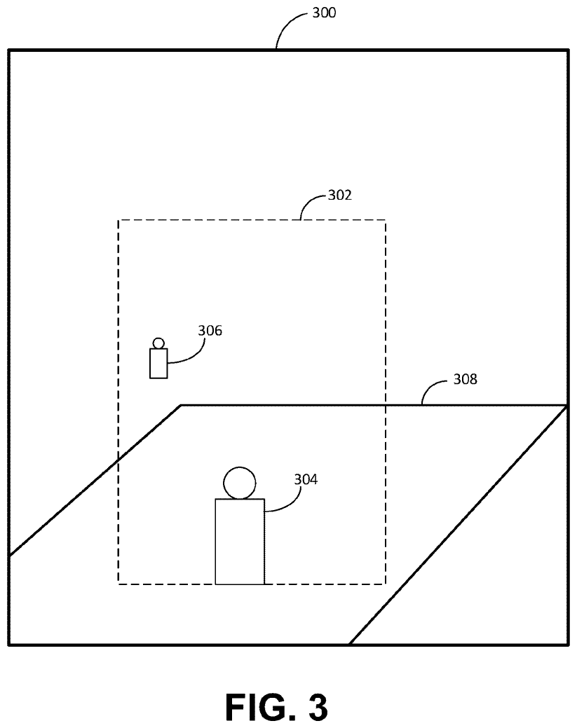

FIG. 2 is a flow diagram illustrating example operations 200 performed by a compliance system (e.g., computing device 100), in accordance with certain aspects of the present disclosure. At block 202, a recording element (e.g., recording element 180, such as a camera) may be used to capture media, such as any combination of videos, images, or audio. For example, the recording element may be used to capture video of an environment, which may include a series of images and audio. In some cases, the media may be captured in response to an activation trigger, as described in more detail with respect to FIG. 3.

FIG. 3 illustrates a scene 300 captured by a recording element, in accordance with certain aspects of the present disclosure. As shown, an activation boundary 302 may be set to trigger video capture. For example, a camera may be configured to capture video upon detecting activity within the activation boundary 302. The activation boundary 302 may be a two-dimensional (2D) activation boundary that may, for example, be set around an area in front of an entryway to a house. While the activation boundary may be a 2D boundary from the perspective of the recording element, a 3D boundary may also be used. For example, the activation boundary may be set as a relative distance from a point of interest (e.g., 2 feet behind a car parked in the captured frame). Video may be captured upon detection of a person 304 within the activation boundary 302.

In some aspects, the captured media may be stored at block 204 (e.g., in memory 115). The captured media may be stored on the cloud in any suitable storage medium. As described, the compliance system may identify whether the captured media includes personal information and delete at least a portion of the media accordingly (e.g., mute audio, delete portions of video, or blur portions of frames in the video). In some aspects, at block 206, the compliance system may extract stored video and delete the video from storage to later replace the video with a processed version of the video with the personal information removed (e.g., deleted, cropped, or blurred).

In some aspects, at block 208, the compliance system may detect one or more features in the media (e.g., via feature identification circuit 126). The feature detection may be performed using a trained machine learning system. The output of the feature detection may be stored as metadata for the media. Identified features (e.g., objects or people) may be stored along with associated timestamps. As a few examples, the identified features may include the identification that one or more individuals are present in the captured video at a specific time, characteristics of one or more individuals (e.g., actions, moods, clothing, etc), and/or one or more objects (e.g., trees or vehicles). For instance, as shown in FIG. 3, the compliance system may detect person 304 and person 306 within scene 300.

At block 210, the compliance system may perform speech detection in some aspects. The speech detection may be performed via a trained machine learning system to identify speech and store the identified speech (e.g., subtitles) along with timestamps. The speech may be from any source within scene 300 (e.g., from person 304 or person 306) or from a source (e.g., another person) not captured within scene 300.

At block 212, the compliance system may align the identified speech with the identified features. For example, at a specific time, the feature detection may detect a person (e.g., person 304) and may detect speech from audio at the same time. In some cases, the compliance system may also detect mouth movement indicative of talking that may correspond to the speech. The detected person or speech may occur at the same time, and therefore, the detected person and the speech may be identified as being aligned in time.

In some aspects of the present disclosure, at block 214, the compliance system may edit the media (e.g., cut, crop, blur, and/or mute one or more portions of the video). For example, any portion of the media that includes identified speech at times when no people are detected in the scene may be edited (e.g., audio muted or the video snipped). If speech is detected in the video, but no people are detected in the captured scene, that indicates that the speech has a source from someone outside the video capture boundary. Therefore, that portion of the video may be deleted.

In some cases, one or more people (e.g., person 304 or person 306) may be identified in the video, yet it may be identified that the individual is not talking (or his mouth movement is not consistent with the identified speech). This would also indicate that the identified speech is from another individual that is outside the video capture boundary. In this case, the associated portion of the video may not be deleted since the video capture is valid (e.g., captures video of a person within the property boundary). Instead, only the audio may be muted to mute the speech from the person that is outside the property boundary.

In some aspects, at block 216, the compliance system may identify a geographical boundary associated with a property. For instance, as shown in FIG. 3, the geographical boundary 308 may be identified. The geographical boundary 308 may be identified using the media captured at block 202, in some aspects. For example, the compliance system may identify the geographical boundary by identifying marks in the captured media (e.g., trees or fences that are known to be at the boundary of the property). In some aspects, the compliance system may receive user input for identifying the geographical boundary. The geographical boundary may correspond to a boundary of a property of a user capturing the media.

In some aspects, at block 218, the compliance system may determine whether detected features in the captured environment are within the identified geographical boundary. For example, the compliance system may detect that person 304 is within geographical boundary 308, and/or detect that person 306 is outside geographical boundary 308.

In some aspects, whether features are within the geographical boundary may be determined by analyzing 2D video data. In some aspects, the compliance system may receive sensor data indicating three-dimensional (3D) sensor data. For instance, the 3D sensor data may indicate depth data associated with one or more features in the captured environment (e.g., depth of objects or people in the captured scene). The depth data may be used to determine whether the features (e.g., person 304 or person 306) in the environment are within the geographical boundary, in some aspects.

At block 214, the compliance system may edit the media, as described herein. For example, any portions of the media that include captured features (e.g., people) that are outside the geographical boundary may be deleted.

As described herein, video capture may be triggered by identifying activity (e.g., using one or more sensors, such as motion or audio sensors) within the activation boundary. Therefore, even if only person 306 is within scene 300 and not inside the geographical boundary, video capture may still be triggered since person 306 is within the activation boundary 302. In this case, if only person 306 is detected in scene 300 and person 306 is outside the geographical boundary 308, the portion of the video showing person 306 may be deleted.

In some aspects, the video capture may be preset. For example, an autonomous electric vehicle may approach a house for delivery of a package and may be time captured. For instance, a user may be aware that a delivery vehicle will approach at 2 pm and, therefore can start recording from 1:58 pm to 2:05 pm to capture the delivery.

In some aspects, previously recorded data may be stored based on a trigger. For example, if a delivery person rings the doorbell (e.g., acting as a trigger), the last 2 minutes of video may be stored retroactively. The system may retroactively capture (e.g., store) what is needed after receiving an activation trigger.

Suppose a portion of the video includes features (e.g., an individual) outside the geographical boundary and also features (e.g., another individual) within the geographical boundary. In that case, the portion of the video showing the features outside the geographical boundary may be blurred or cropped. For example, if the compliance system detects person 304 within geographical boundary 308 (e.g., indicating a valid capture) and person 306 outside geographical boundary 308, such a portion of the video may not be deleted. Instead, only the portion of frames in the video showing person 306 may be blurred or cropped.

In some aspects, the detected feature described herein may include audio. The compliance system may determine whether a captured audio is from a source outside the geographical boundary 308. This may be performed by analyzing the audio using machine learning.

In some aspects, a baseline audio level may be identified. The distance from the camera capturing the media to the source of the audio may be determined by comparing the audio to the baseline audio level. In other words, it may be known that the volume of audio originating from outside boundary 308 is less than a threshold, indicating that the audio source is outside boundary 308. At block 214, editing the media may involve muting the audio based on the audio being determined to have a source from outside the geographical boundary 308. For example, if it is determined that the speech is from person 306, the speech in the audio may be muted.

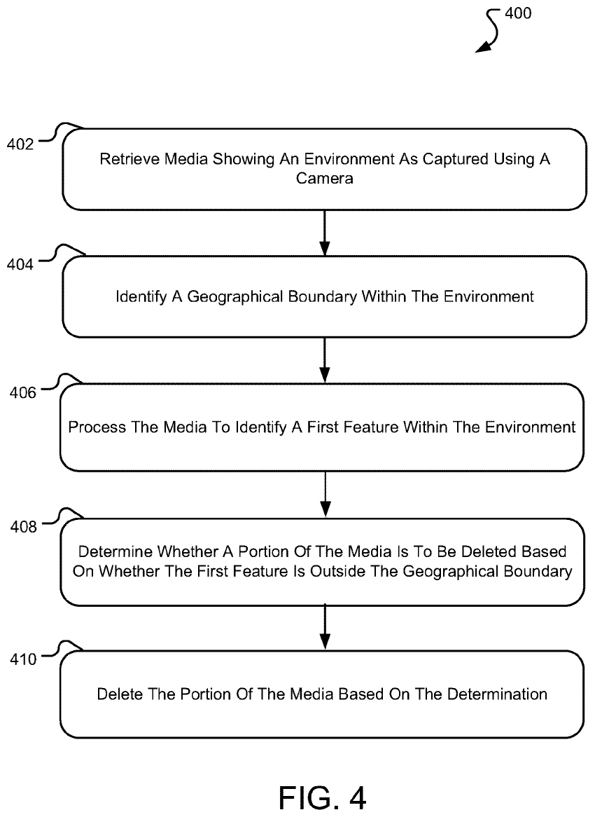

FIG. 4 illustrates example operations 400 for media processing, in accordance with certain aspects of the present disclosure. The operations 400 may be performed, for example, by a compliance system, such as the computing device 100.

At block 402, the compliance system may retrieve media showing an environment as captured using a camera. The media may be captured in response to detection of activity within a 2D activation boundary (e.g., activation boundary 302) in a scene capture by the camera.

At block 404, the compliance system may identify a geographical boundary (e.g., geographical boundary 308) within the environment. The geographical boundary may include a boundary associated with a property of a user.

At block 406, the compliance system may process the media to identify a first feature (e.g., object, person, or audio) within the environment. At block 408, the compliance system may determine whether a portion of the media is to be deleted based on whether the first feature is outside the geographical boundary.

At block 410, the compliance system may delete the portion of the media based on the determination. Deleting the portion of the media includes at least one of blurring a portion of one or more frames associated with the media, cropping a portion of one or more frames associated with the media, or muting a portion of an audio associated with the media.

In some aspects, the media includes audio. To identify the first features, the compliance system may identify speech in the audio. To determine whether the portion of the media is to be deleted, the compliance system determines whether to mute at least a portion of the audio based on the speech. For example, to determine whether to mute at least a portion of the audio, the compliance system detects whether a source of the speech is within the geographical boundary.

In some aspects, the first feature includes an audio feature. To detect whether the audio feature is outside the geographical boundary, the compliance system may detect whether a source of the audio feature is outside the geographical boundary (e.g., based on a level of volume of the audio being less than a threshold).

In some aspects, the compliance system may detect whether a second feature (e.g., a second person 304, where the first feature may be a first person 306) is within the geographical boundary. To delete the portion of the media, the compliance system may crop or blur the portion of the media associated with the first feature (e.g., person 306) in response to the second feature (e.g., person 304) being within the geographical boundary.

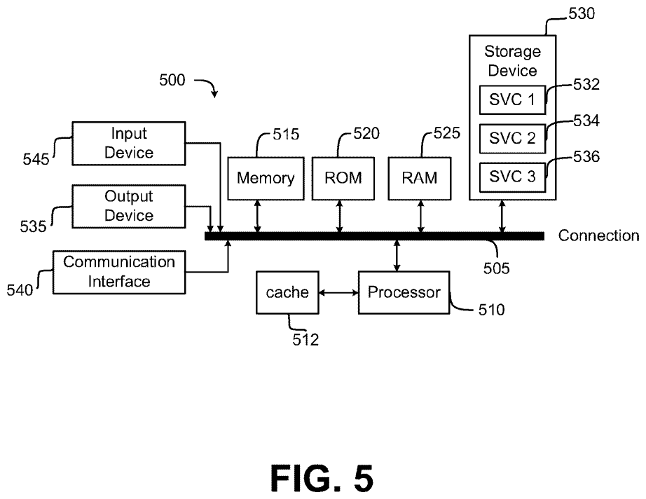

FIG. 5 illustrates an architecture of a computing system 500 wherein the components of the system 500 are in electrical communication with each other using a connection 505, such as a bus. Exemplary system 500 includes a processing unit (CPU or processor) 510 and a system connection 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware or software service, such as service 1 532, service 2 534, and service 3 536 stored in storage device 530, configured to control the processor 510 as well as a special-purpose processor where software instructions are incorporated into the actual processor design. The processor 510 may be a completely self-contained computing system, containing multiple cores or processors, a bus, memory controller, cache, etc. A multi-core processor may be symmetric or asymmetric.

To enable client interaction with the computing system 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a client to provide multiple types of input to communicate with the computing system 500. The communications interface 540 can generally govern and manage the client input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include services 532, 534, 536 for controlling the processor 510. Other hardware or software modules are contemplated. The storage device 530 can be connected to the system connection 505. In one aspect, a hardware module that performs a particular function can include the software component stored in a computer-readable medium in connection with the necessary hardware components, such as the processor 510, connection 505, output device 535, and so forth, to carry out the function.

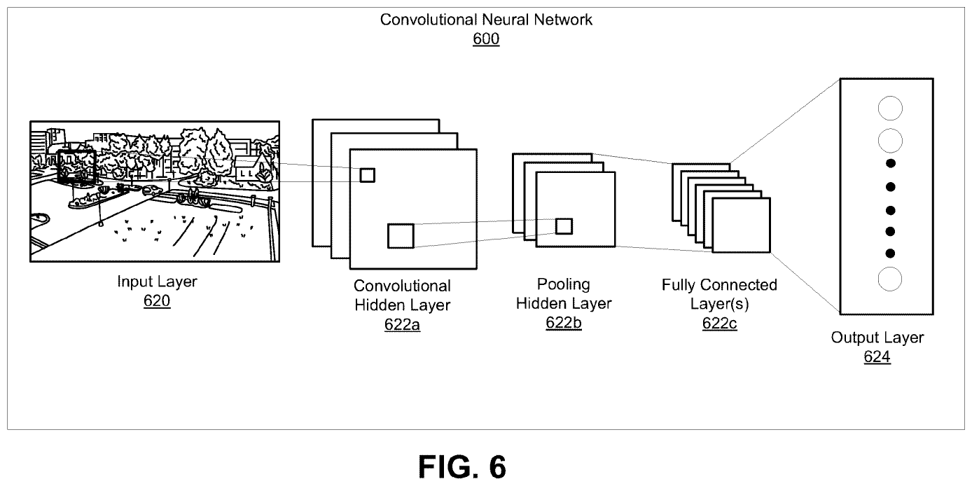

FIG. 6 is an illustrative example of a convolutional neural network 600 (CNN 600). The CNN 600 is an example machine learning system that may be used for object or speech detection. The input layer 620 of the CNN 600 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 622a, an optional non-linear activation layer, a pooling hidden layer 622b, and fully connected hidden layers 622c to get an output at the output layer 624. While only one of each hidden layer is shown in FIG. 6, one of ordinary skill will appreciate that multiple convolutional hidden layers, non-linear layers, pooling hidden layers, and/or fully connected layers can be included in the CNN 600. As previously described, the output can indicate a single class of an object or can include a probability of classes that best describe the object in the image. A class or probability of classes can be generated for each object in an image.

The first layer of the CNN 600 is the convolutional hidden layer 622a. The convolutional hidden layer 622a analyzes the image data of the input layer 620. Each node of the convolutional hidden layer 622a is connected to a region of nodes (pixels) of the input image called a receptive field. The convolutional hidden layer 622a can be considered as one or more filters (each filter corresponding to a different activation or feature map), with each convolutional iteration of a filter being a node or neuron of the convolutional hidden layer 622a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 622a. Each connection between a node and a receptive field for that node learns a weight and, in some cases, an overall bias such that each node learns to analyze its particular local receptive field in the input image. Each node of the hidden layer 622a will have the same weights and bias (called a shared weight and a shared bias). For example, the filter has an array of weights (represented by numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 622a is due to each node of the convolutional layer being applied to its corresponding receptive field. For example, a filter of the convolutional hidden layer 622a can begin in the top-left corner of the input image array and can convolve around the input image. As noted above, each convolutional iteration of the filter can be considered a node or neuron of the convolutional hidden layer 622a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 622a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 622a.

The mapping from the input layer to the convolutional hidden layer 622a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 622a can include several activation maps in order to identify multiple features in an image. The example shown in FIG. 6 includes three activation maps. Using three activation maps, the convolutional hidden layer 622a can detect three different kinds of features, with each feature being detectable across the entire image.

In some examples, a non-linear hidden layer can be applied after the convolutional hidden layer 622a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the network 600 without affecting the receptive fields of the convolutional hidden layer 622a.

The pooling hidden layer 622b can be applied after the convolutional hidden layer 622a (and after the non-linear hidden layer when used). The pooling hidden layer 622b is used to simplify the information in the output from the convolutional hidden layer 622a. For example, the pooling hidden layer 622b can take each activation map output from the convolutional hidden layer 622a and generates a condensed activation map (or feature map) using a pooling function. Max-pooling is one example of a function performed by a pooling hidden layer. Other forms of pooling functions be used by the pooling hidden layer 622a, such as average pooling, L2-norm pooling, or other suitable pooling functions. A pooling function (e.g., a max-pooling filter, an L2-norm filter, or other suitable pooling filter) is applied to each activation map included in the convolutional hidden layer 622a. In the example shown in FIG. 6, three pooling filters are used for the three activation maps in the convolutional hidden layer 622a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 622a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 622a having a dimension of 24×24 nodes, the output from the pooling hidden layer 622b will be an array of 8×8 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 600.

The final layer of connections in the network is a fully-connected layer that connects every node from the pooling hidden layer 622b to every one of the output nodes in the output layer 624. Using the example above, the input layer includes 28×28 nodes encoding the pixel intensities of the input image, the convolutional hidden layer 622a includes 3×24×24 hidden feature nodes based on application of a 5×5 local receptive field (for the filters) to three activation maps, and the pooling layer 622b includes a layer of 3×12×12 hidden feature nodes based on application of max-pooling filter to 2×2 regions across each of the three feature maps. Extending this example, the output layer 624 can include ten output nodes. In such an example, every node of the 3×12×12 pooling hidden layer 622b is connected to every node of the output layer 624.

The fully connected layer 622c can obtain the output of the previous pooling layer 622b (which should represent the activation maps of high-level features) and determines the features that most correlate to a particular class. For example, the fully connected layer 622c layer can determine the high-level features that most strongly correlate to a particular class, and can include weights (nodes) for the high-level features. A product can be computed between the weights of the fully connected layer 622c and the pooling hidden layer 622b to obtain probabilities for the different classes. For example, if the CNN 600 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 624 can include an M-dimensional vector (in the prior example, M=10), where M can include the number of classes that the program has to choose from when classifying each object in the image. Other example outputs can also be provided. Each number in the N-dimensional vector can represent the probability an object is of a certain class. In one illustrative example, if a 10-dimensional output vector represents ten different classes of objects is [0 0 0.05 0.8 0 0.15 0 0 0 0], the vector indicates that there is a 5% confidence or probability that an object in the image is the third class of object (e.g., a dog), an 80% confidence or probability that the object in the image is the fourth class of object (e.g., a human), and a 15% confidence or probability that the object in the image is the sixth class of object (e.g., a kangaroo). The confidence or probability for a class can be considered a confidence level that the object is part of that class.

The CNN 600 can be trained using any suitable training process. For example, the CNN 600 can adjust the weights of the various layers of the CNN 600 using a training process called backpropagation. Backpropagation can include a forward pass, a loss function, a backward pass, and a parameter (e.g., weight, bias, or other parameter) update. The forward pass, loss function, backward pass, and parameter update is performed for one training iteration. The process can be repeated for a certain number of iterations for each set of training images until the CNN 600 is trained well enough so that the weights (and/or other parameters) of the layers are accurately tuned.

For the example of identifying objects in images, the forward pass can include passing a training image through the CNN 600. The weights are initially randomized before the deep learning neural CNN 600 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the CNN 600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the CNN 600 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The deep learning neural CNN 600 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wi denotes the initial weight, and η denotes a learning rate. The learning rate can be set to any suitable value, with a high learning rate including larger weight updates and a lower value indicating smaller weight updates.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts in this disclosure may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” or “one or more of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.

### Example Aspects

Clause 1. An apparatus for media processing, comprising: a memory; and one or more processors coupled to the memory, the one or more processors being configured to: retrieve media showing an environment as captured using a recording element; identify or receive input to identify a geographical boundary within the environment; process the media to identify a first feature within the environment; determine whether a portion of the media is to be deleted based on whether the first feature is outside the geographical boundary; and delete the portion of the media based on the determination.

Clause 2. The apparatus of clause 1, wherein the media is captured in response to detection of activity within a two-dimensional (2D) activation boundary in a scene capture by the recording element, the 2D activation boundary being different than the geographical boundary.

Clause 3. The apparatus of any one of clauses 1-2, wherein the geographical boundary defines a boundary associated with a property of a user.

Clause 4. The apparatus of any one of clauses 1-3, wherein: the media includes audio; to identify the first features, the one or more processors are configured to identify speech in the audio; and to determine whether the portion of the media is to be deleted, the one or more processors are configured to determine whether to mute at least a portion of the audio based on the speech.

Clause 5. The apparatus of clause 4, wherein to determine whether to mute at least a portion of the audio, the one or more processors are configured to detect whether a source of the speech is within the geographical boundary.

Clause 6. The apparatus of any one of clauses 1-5, wherein the one or more processors are configured to: align detected audio and object features; and determine whether the portion of the media is to be deleted based on the alignment of the detected audio and object features.

Clause 7. The apparatus of any one of clauses 1-6, wherein the first feature includes an object.

Clause 8. The apparatus of any one of clauses 1-7, wherein: the first feature includes an audio feature; and to detect whether the audio feature is outside the geographical boundary, the one or more processors are configured to detect whether a source of the audio feature is outside the geographical boundary.

Clause 9. The apparatus of any one of clauses 1-8, wherein: the one or more processors are configured to detect whether a second feature is within the geographical boundary; and to delete the portion of the media, the one or more processors are configured to crop or blur the portion of the media associated with the first feature in response to the second feature being within the geographical boundary.

Clause 10. The apparatus of any one of clauses 1-9, wherein deleting the portion of the media includes at least one of blurring a portion of one or more frames associated with the media, cropping a portion of one or more frames associated with the media, or muting a portion of an audio associated with the media.

Clause 11. A method for media processing, comprising: retrieving media showing an environment as captured using a recording element; identifying or receive input to identify a geographical boundary within the environment; processing the media to identify a first feature within the environment; determining whether a portion of the media is to be deleted based on whether the first feature is outside the geographical boundary; and deleting the portion of the media based on the determination.

Clause 12. The method of clause 11, wherein the media is captured in response to detection of activity within a two-dimensional (2D) activation boundary in a scene capture by the recording element, the 2D activation boundary being different than the geographical boundary.

Clause 13. The method of any one of clauses 11-12, wherein the geographical boundary defines a boundary associated with a property of a user.

Clause 14. The method of any one of clauses 11-13, wherein: the media includes audio; identifying the first features includes identify speech in the audio; and determining whether the portion of the media is to be deleted includes determining whether to mute at least a portion of the audio based on the speech.

Clause 15. The method of clause 14, wherein determining whether to mute at least a portion of the audio includes detecting whether a source of the speech is within the geographical boundary.

Clause 16. The method of any one of clauses 11-15, further comprising aligning detected audio and object features, wherein the one or more processors are configured to to determine whether the portion of the media is to be deleted based on the alignment of the detected audio and object features.

Clause 17. The method of any one of clauses 11-16, wherein the first feature includes an object.

Clause 18. The method of any one of clauses 11-17, wherein: the first feature includes an audio feature; and to detect whether the audio feature is outside the geographical boundary, the one or more processors are configured to detect whether a source of the audio feature is outside the geographical boundary.

Clause 19. The method of any one of clauses 11-18, further comprising detecting whether a second feature is within the geographical boundary, wherein deleting the portion of the media including cropping or blurring the portion of the media associated with the first feature in response to the second feature being within the geographical boundary.

Clause 20. A non-transitory computer-readable medium having instructions stored thereon, that when executed by one or more processors, cause the one or more processors to: retrieve media showing an environment as captured using a recording element; identify or receive input to identify a geographical boundary within the environment; process the media to identify a first feature within the environment; determine whether a portion of the media is to be deleted based on whether the first feature is outside the geographical boundary; and delete the portion of the media based on the determination.

1. An apparatus for media processing, the apparatus comprising:
a memory; and
one or more processors coupled to the memory, the one or more processors being configured to:
retrieve media showing an environment as captured using a recording element;
identify a geographical boundary within the environment;
process the media to identify a first feature within the environment; and
determine whether to delete a portion of the media based on whether the first feature is outside the geographical boundary.

2. The apparatus of claim 1, wherein the media is captured in response to detection of activity within a two-dimensional (2D) activation boundary in a scene capture by the recording element, the 2D activation boundary being different than the geographical boundary.

3. The apparatus of claim 1, wherein the geographical boundary defines a boundary associated with a property of a user.

4. The apparatus of claim 1, wherein:
the media includes audio;
to identify the first features, the one or more processors are configured to identify speech in the audio; and
to determine whether to delete the portion of the media, the one or more processors are configured to determine whether to mute at least a portion of the audio based on the speech.

5. The apparatus of claim 4, wherein to determine whether to mute at least a portion of the audio, the one or more processors are configured to determine whether a source of the speech is within the geographical boundary.

6. The apparatus of claim 1, wherein the one or more processors are configured to:
align detected audio and object features; and
determine whether to delete the portion of the media based on the alignment of the detected audio and object features.

7. The apparatus of claim 1, wherein the first feature includes an object.

8. The apparatus of claim 1, wherein:
the first feature includes an audio feature; and
to determine whether the audio feature is outside the geographical boundary, the one or more processors are configured to determine whether a source of the audio feature is outside the geographical boundary.

9. The apparatus of claim 1, wherein:
the one or more processors are configured to determine whether a second feature is within the geographical boundary; and
to delete the portion of the media, the one or more processors are configured to crop or blur the portion of the media associated with the first feature in response to the second feature being within the geographical boundary.

10. The apparatus of claim 1, wherein deleting the portion of the media includes at least one of blurring a portion of one or more frames associated with the media, cropping a portion of one or more frames associated with the media, or muting a portion of an audio associated with the media.

11. A method for media processing, comprising:
retrieving media showing an environment as captured using a recording element;
identifying a geographical boundary within the environment;
processing the media to identify a first feature within the environment; and
determining whether to delete a portion of the media based on whether the first feature is outside the geographical boundary.

12. The method of claim 11, wherein the media is captured in response to detection of activity within a two-dimensional (2D) activation boundary in a scene capture by the recording element, the 2D activation boundary being different than the geographical boundary.

13. The method of claim 11, wherein the geographical boundary defines a boundary associated with a property of a user.

14. The method of claim 11, wherein:
the media includes audio;
identifying the first features includes identify speech in the audio; and
determining whether to delete the portion of the media includes determining whether to mute at least a portion of the audio based on the speech.

15. The method of claim 14, wherein determining whether to mute at least a portion of the audio includes determining whether a source of the speech is within the geographical boundary.

16. The method of claim 11, further comprising:
aligning detected audio and object features; and
determining whether to delete the portion of the media based on the alignment of the detected audio and object features.

17. The method of claim 11, wherein the first feature includes an object.

18. The method of claim 11, wherein:
the first feature includes an audio feature; and
determining whether the audio feature is outside the geographical boundary, comprises determining whether a source of the audio feature is outside the geographical boundary.

19. The method of claim 11, further comprising determining whether a second feature is within the geographical boundary, wherein deleting the portion of the media including cropping or blurring the portion of the media associated with the first feature in response to the second feature being within the geographical boundary.

20. A non-transitory computer-readable medium having instructions stored thereon, that when executed by one or more processors, cause the one or more processors to:
retrieve media showing an environment as captured using a recording element;
identify a geographical boundary within the environment;
process the media to identify a first feature within the environment; and
determine whether to delete a portion of the media based on whether the first feature is outside the geographical boundary.
